(19) United States
(12) Patent Application Publication
(10) Pub. No.: US 2020/0283143 A1
(43) Pub. Date: Sep. 10, 2020

(54) NON-PLANAR FRAME STRUCTURE OF AN UNMANNED AERIAL VEHICLE

(71) Applicant: IDEAFORGE TECHNOLOGY PVT. LTD., NAVI MUMBAI (IN)

(72) Inventors: Rahul SINGH, Navi Mumbai (IN); Vishal KHETMALI, Navi Mumbai (IN)

(21) Appl. No.: 16/644,980

(22) PCT Filed: Aug. 30, 2018
(86) PCT No.: PCT/IB2018/056626

§ 371 Date: Mar. 6, 2020

(30) Foreign Application Priority Data
Sep. 9, 2017 (IN) 201721031927

(51) Int. Cl. B64C 39/02

(52) U.S. Cl. CPC B64C 39/024; B64C 2201/141; B64C 2201/108; B64C 2201/027

(57) ABSTRACT

The present disclosure pertains to non-planar frame structure of a multi-rotor unmanned aerial vehicle (UAV). Aspects of the present disclosure provide frame structure of a UAV that includes at least two rods 102-1 and 102-2, and one or more center supporting plates 106 holding the at least two rods 102-1 and 102-2 to form a rigid structure, wherein the at least two rods 102-1 and 102-2 are overlapped to form a crossed structure wherein ends of the at least two rods 102-1 and 102-2 construe a polygon, and wherein a plurality of propellers 204 are operatively coupled at the ends of the at least two rods to enable flight of the UAV. The frame structure includes at least four overlapping arms 104-1, 104-2, 104-3 and 104-2, at least two of which are present in different planes and thus, the present disclosure provides a non-planar frame structure of a multi-rotor UAV.

### TECHNICAL FIELD

The present disclosure relates generally to the field of rotary systems, and more particularly to non-planar frame structure of a multi-rotor unmanned aerial vehicle (UAV).

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Frame structure of an Unmanned Aerial Vehicle (UAV) is the most basic structure or skeleton that holds all the components of the UAV together to provide a compact and easy to assemble structural design of the UAV. The frame structure is designed to be tough and rigid to withstand crashes and minimize vibrations.

Conventional structure of a multi-rotor UAV usually includes either a monolithic type of UAV body frame or a body frame that includes two or more arm with multiple supporting plates. The monolithic type of UAV body frame is a single rigid element whereas the other type of body frame is made up of two or more separate arms connected together at center with multiple center supporting plates, such that all the arms connected to the center plate are usually in a same plane.

Even though these basic configurations provide simplicity to aerodynamic concepts for flying of the UAV, the monolithic type of UAV body frame in order to achieve the required strength characteristics for larger frame construction tends to be heavier whereas the body frame with multiple arms and center supporting plates requires a lot of mechanical fixtures/fasteners to provide rigidity to their structure. In addition, such structures require multiple center supporting plates for balanced distribution of body weight leading to an increase in weight of the UAV. In addition, balancing of bending loads of the UAV body requires additional supports on the UAV body.

There is therefore a need to overcome problems associated with frame structure of conventional UAV with a better structure and frame design that aims to provide a simple and rigid structure with lesser mechanical components and lesser center supporting plates leading to an optimized UAV body structure with improved weight efficiency.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

A general object of the present disclosure is to provide frame structure of an Unmanned Aerial Vehicle (UAV) that incorporates less number of mechanical fixtures/fasteners.

Another object of the present disclosure is to provide frame structure of a UAV that allows design elements/parameters of the UAV to remain the same for scaling up of the size of the UAV.

Another object of the present disclosure is to provide frame structure of a UAV with an improved structural strength.

Another object of the present disclosure is to provide frame structure of a UAV having rigid structure to minimize vibrations.

Another object of the present disclosure is to provide frame structure of a UAV that balances bending loads of the frame structure.

Another object of the present disclosure is to provide frame structure of a UAV that has improved weight efficiency for minimized power consumption.

Another object of the present disclosure is to provide frame structure of a UAV that is easy to manufacture/assemble.

Another object of the present disclosure is to provide frame structure of a UAV having modular design.

These and other objects of the present invention will become readily apparent from the following detailed description taken in conjunction with the accompanying drawings.

### SUMMARY

Aspects of the present disclosure relate to rotary systems. In particular, the present disclosure provides non-planar frame structure of a multi-rotor unmanned aerial vehicle (UAV).

In an aspect, the present disclosure provides a UAV that includes at least two rods, and one or more center supporting plates holding the at least two rods to form a rigid structure, wherein the at least two rods are overlapped to form a crossed structure wherein ends of the at least two rods construe a polygon, and wherein a plurality of propellers are operatively coupled at the ends of the at least two rods to enable flight of the UAV.

In an aspect, the at least two rods are held firmly with the help of fasteners including any or a combination of screws, bolts and mounting brackets.

In an aspect, the rigid structure includes at least four overlapping arms, where at least two arms are present in different planes.

In an aspect, each of the at least two rods are present in a different plane.

In an aspect, ‘n−1’ number of center supporting plates hold ‘n’ number of rods to form the rigid structure.

In an aspect, the rigid structure is extended to a quadcopter by placing a first link above the center supporting plate and a second link below the center supporting plate. In another aspect, the rigid structure is extended to a hexacopter by placing a first link above a first center supporting plate, a second link below a second center supporting plate and sandwiching a third link between the first center supporting plate and the second center supporting plate to make a hexacopter.

In an aspect, aerodynamic controllability for flight of the UAV is controlled with a programmed flight controller.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary representation of a rotor-blade UAV with non-planar frame structure in accordance to an embodiment of the present disclosure.

FIG. 2 illustrates an exemplary representation of proposed non-planar frame structure of the rotor-blade UAV in accordance with an embodiment of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

The present disclosure provides an Unmanned Aerial Vehicle (UAV) including at least two rods, and one or more center supporting plates holding the at least two rods to form a rigid structure, wherein the at least two rods are overlapped to form a crossed structure wherein ends of the at least two rods construe either a regular or an irregular polygon, and wherein a plurality of propellers are operatively coupled at the ends of the at least two rods to enable flight of the UAV.

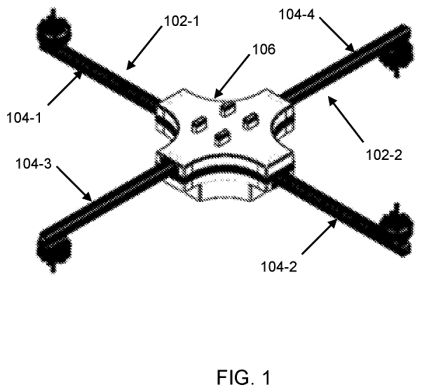

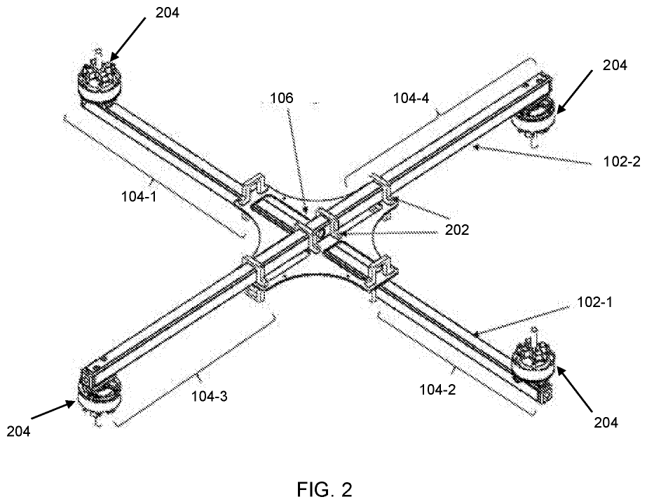

FIG. 1 illustrates an exemplary representation of a rotor-blade UAV with non-planar frame structure in accordance to an embodiment of the present disclosure. In an aspect, frame structure of the rotor-blade UAV can include two rigid rods 102-1 and 102-2 clamped so as to form a diagonally crossed structure having four overlapped arms 104-1, 104-2, 104-3 and 104-4. In an aspect, the two rigid rods 102-1 and 102-2 can be clamped at center by a center supporting plate 106 such that ends of the rods 102-1 and 102-2 can construe either a regular or an irregular polygon, and the overlapped arms 104-1, 104-2, 104-3 and 104-4 can be supported by mechanical fasteners 202 (as clearly shown in FIG. 2) including any or a combination of screws, bolts, mounting brackets and the like.

In an aspect, each of the two rods 102-1 and 102-2 can be present in a different plane.

In an aspect, the frame structure provides continuity of crossed arms 104-1, 104-2, 104-3 and 104-4 by joining of the rigid rods 102-1 and 102-2 forming a single rigid structure. In an aspect, at least two overlapping arms out of the four arms 104-1, 104-2, 104-3 and 104-4 can be present in different planes to form a non-planar frame structure.

In an aspect, it would be appreciated that use of the proposed frame structure can be extended to Quadcopters, Hexacopters, Octacopters and other like devices by using ‘n−1’ number of center supporting plates for clamping/holding ‘n’ number of rods. For instance, in case of a hexacopter, three rods can form a crossed structure by using two center supporting plates to firmly hold/clamp the rods in place such that six overlapped arms can be formed, ends of which can form either a regular or an irregular polygon.

In an aspect, the frame structure can be extended to a quadcopter by placing a first link above the center supporting plate and a second link below the center supporting plate. In another aspect, the frame structure can be extended to a hexacopter by placing a first link above a first center supporting plate, a second link below a second center supporting plate and sandwiching a third link between the first center supporting plate and the second center supporting plate

In an aspect, aerodynamic controllability for flight of the UAV with overlapped arms 104-1, 104-2, 104-3 and 104-4 in different planes can be controlled with an adequately programmed flight controller (not shown). The programmed flight controller can control rotational velocity of the propellers 204 to provide for easy maneuverability of the UAV.

In an aspect, the proposed frame structure provides a rigid frame with less number of mechanical fasteners to clamp the rods 102-1 and 102-2 at center to form crossed non-planar structure.

In an aspect, it would be appreciated that bending loads of a conventional body structure of the UAV can be balanced using the proposed frame structure.

In an exemplary aspect, the proposed UAV is designed in such a way that design elements/parameters of the UAV remain the same for scaling up of the size of the UAV, wherein strong rigid rods of appropriate lengths can be joined together at a centre to form body frame of the UAV.

FIG. 2 illustrates an exemplary representation of proposed non-planar frame structure of the rotor-blade UAV in accordance with an embodiment of the present disclosure. In an aspect, as illustrated in FIG. 1, two rigid rods 102-1 and 102-2 can be overlapped and clamped at center such that overlapped rods 102-1 and 102-2 are not co-planar, and thus, providing a non-planar UAV frame structure.

In an aspect, a center supporting plate 106 can be used to firmly connect the rods 102-1 and 102-2 in order to form four overlapped arms 104-1, 104-2, 104-3 and 104-4, where at least two arms are present in different planes.

In an aspect, mechanical fasteners 202 including any or a combination of screws, bolts, mounting brackets and the like can be used to firmly hold/clamp the overlapped arms 104-1, 104-2, 104-3 and 104-4 at the center.

In an aspect, the proposed frame structure can further include a plurality of propellers 204 to enable flight of the UAV. The propellers 204 can be operatively coupled at ends of the rods 102-1 and 102-2. In an aspect, axial direction of rotation of one or more propellers 204 can be devised at a defined angle so as to allow easy maneuverability of the UAV. As illustrated in FIG. 2, propellers 204 coupled at the ends of rod 102-2 have an axial direction of rotation opposite to the propellers 204 coupled at the ends of rod 102-1 to allow regulated lift and descent of the UAV.

In an aspect, the proposed frame structure is optimized to provide a higher structural strength with minimum hardware requirement. In addition, the proposed diagonally crossed frame structure is further optimized to provide weight efficiency for minimizing power requirements.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides frame structure of an Unmanned Aerial Vehicle (UAV) that incorporates less number of mechanical fasteners.

The present disclosure provides frame structure of a UAV that allows design elements/parameters of the UAV to remain the same for scaling up of the size of the UAV.

The present disclosure provides frame structure of a UAV with an improved structural strength.

The present disclosure provides frame structure of a UAV having rigid structure to minimize vibrations.

The present disclosure provides frame structure of a UAV that balances bending loads of the frame structure.

The present disclosure provides frame structure of a UAV that has improved weight efficiency for minimized power consumption.

The present disclosure provides frame structure of a UAV that is easy to manufacture/assemble.

The present disclosure provides frame structure of a UAV having modular design.

We claim:

1. An Unmanned Aerial Vehicle (UAV) comprising:
at least two rods; and
one or more center supporting plates holding the at least two rods to form a rigid structure,
wherein the at least two rods are overlapped to form a crossed structure wherein ends of the at least two rods construe a polygon, and
wherein a plurality of propellers are operatively coupled at the ends of the at least two rods to enable flight of the UAV.

2. The UAV of claim 1, wherein the at least two rods are held firmly with the help of fasteners comprising any or a combination of screws, bolts and mounting brackets.

3. The UAV of claim 1, wherein the rigid structure comprises at least four overlapping arms, where at least two arms are present in different planes.

4. The UAV of claim 1, wherein each of the at least two rods are present in a different plane.

5. The UAV of claim 1, wherein ‘n−1’ number of center supporting plates hold ‘n’ number of rods to form the rigid structure.

6. The UAV of claim 1, wherein the rigid structure is extended to a quadcopter by placing a first link above the center supporting plate and a second link below the center supporting plate.

7. The UAV of claim 1, wherein the rigid structure is extended to a hexacopter by placing a first link above a first center supporting plate, a second link below a second center supporting plate and sandwiching a third link between the first center supporting plate and the second center supporting plate.

8. The UAV of claim 1, wherein aerodynamic controllability for flight of the UAV is controlled with a programmed flight controller.
